(19) United States
(12) Patent Application Publication
(10) Pub. No.: US 2024/0412752 A1
(43) Pub. Date: Dec. 12, 2024

(54) AUDIO SIGNAL ENHANCEMENT SYSTEM

(71) Applicant: INTELLIGO TECHNOLOGY INC., Zhubei City (TW)

(72) Inventors: MIN-HSUAN LEE, Zhubei City (TW); CHEN-CHU HSU, Zhubei City (TW); YAO-CHUN LIU, Zhubei City (TW); TSUNG-LIANG CHEN, Zhubei City (TW)

(21) Appl. No.: 18/466,910

(22) Filed: Sep. 14, 2023

(30) Foreign Application Priority Data
Jun. 6, 2023 (TW) 112121008

(51) Int. Cl. G10L 21/0316; G10L 21/0208; G10L 25/78

(52) U.S. Cl. CPC G10L 21/0316; G10L 21/0208; G10L 25/78

(57) ABSTRACT

An audio signal enhancement system is disclosed. The audio signal enhancement system includes a neural network-like human voice detection module and a frequency shifting module. The neural network-like human voice detection module is used to detect a human voice of an input signal it receives. The frequency shifting module is coupled to the neural network-like human voice detection module and used to perform a frequency shifting process on the human voice to generate an enhanced human voice.

### BACKGROUND OF THE INVENTION

### 1. Field of the Invention

The invention relates to audio signal processing; in particular, to an audio signal enhancement system.

### 2. Description of the Prior Art

In general, the hearing-impaired person usually has a more serious hearing-impaired degree at high frequencies, and the high-frequency components of speech can be moved to low-frequency by conventional frequency shifting methods, so that the hearing-impaired person can hear more clearly to speech, thereby improving semantic comprehension.

However, because the frequency spectrum of consonants (gassy, fricative) in speech is similar to the noise spectrum, the conventional frequency shifting method will also move the high-frequency components of the noise to low-frequency in a noisy environment, thereby causing misunderstandings for the hearing-impaired person. In addition, in a quiet environment, after the conventional frequency shifting method shifts the high-frequency components of speech to low-frequency, since the sub-tone spectrum is similar to the noise spectrum, the hearing-impaired person may identify the processed signal as specific noise.

Therefore, the above-mentioned problems encountered in the prior art still need to be solved.

### SUMMARY OF THE INVENTION

Therefore, the invention provides an audio signal enhancement system to solve the above-mentioned problems of the prior arts.

A preferred embodiment of the invention is an audio signal enhancement system. In this embodiment, the audio signal enhancement system includes a neural network-like human voice detection module and a frequency shifting module. The neural network-like human voice detection module is configured to detect a human voice part of an input signal it receives. The frequency shifting module is coupled to the neural network-like human voice detection module and configured to perform a frequency shifting process on the human voice part to generate an enhanced human voice part.

In an embodiment, the audio signal enhancement system further includes a neural network-like human voice noise reduction module, which is coupled to a neural network-like human voice detection module to eliminate an environmental noise part in the input signal and then output it to the neural network-like human voice detection module.

In an embodiment, the audio signal enhancement system further includes a first conversion module, which is coupled to the neural network-like human voice noise reduction module to convert an original signal into the input signal and then output it to the neural network-like human voice noise reduction module.

In an embodiment, the audio signal enhancement system further includes a second conversion module, which is coupled to a frequency shifting module to convert the enhanced human voice into an enhanced output signal and then output it.

In an embodiment, the input signal further includes an environmental noise part. The audio signal enhancement system further includes a neural network-like human voice noise reduction module, which is coupled to the frequency shifting module and the neural network-like human voice detection module to receive the enhanced human voice part and the environmental noise part and eliminate the environmental noise part and then output the enhanced human voice part.

In an embodiment, the audio signal enhancement system further includes a first conversion module, which is coupled to the neural network-like human voice detection module to convert an original signal into the input signal and then output it to the neural network-like human voice detection module.

In an embodiment, the audio signal enhancement system further includes a second conversion module, which is coupled to the neural network-like human voice noise reduction module to convert the enhanced human voice into an enhanced output signal and then output it.

In an embodiment, the frequency shifting module can use any frequency shifting method to perform a frequency shifting processing on the human voice part to reduce its high-frequency component to low-frequency component and needs of different users can be met through parameter adjustment.

Compared to the prior art, the audio signal enhancement system of the invention is a frequency shifting system combined with a neural network-like noise reduction system and the powerful modeling ability of a neural network is used to determine whether the environment contains a human voice part and an arbitrary frequency shifting method is used to shift only the human voice part to avoid that noise is also frequency-shifted to ensure the maintenance of semantic understanding. At the same time, it is equipped with a neural network-like noise reduction module to preserve the human voice part and eliminate environmental noise part to avoid confusion for the hearing-impaired person and improve their semantic understanding.

The advantage and spirit of the invention may be understood by the following detailed descriptions together with the appended drawings.

### BRIEF DESCRIPTION OF THE APPENDED DRAWINGS

FIG. 1 illustrates a schematic diagram of an audio signal enhancement system according to a first preferred embodiment of the invention.

FIG. 2 illustrates a schematic diagram of an audio signal enhancement system according to a second preferred embodiment of the invention.

FIG. 3 illustrates a schematic diagram of an audio signal enhancement system according to a third preferred embodiment of the invention.

FIG. 4 illustrates a schematic diagram of an audio signal enhancement system according to a fourth preferred embodiment of the invention.

### DETAILED DESCRIPTION OF THE INVENTION

A first preferred embodiment according to the invention is an audio signal enhancement system. In this embodiment, the audio signal enhancement system can be applied to hearing aids to assist hearing-impaired persons to hear high-frequency voice components, thereby improving semantic understanding.

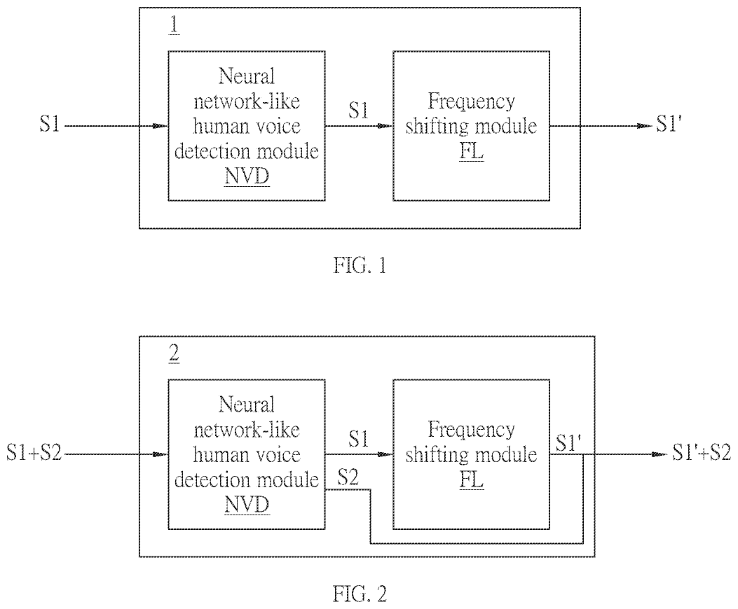

Please refer to FIG. 1, which is a schematic diagram of an audio signal enhancement system 1 according to a first preferred embodiment of the invention. As shown in FIG. 1, the audio signal enhancement system 1 includes a neural network-like human voice detection module NVD and a frequency shifting module FL. The frequency shifting module FL is coupled to the neural network human voice detection module NVD.

When the neural network-like human voice detection module NVD receives an input signal from external environment, the neural network-like human voice detection module NVD will use the powerful modeling ability of the neural network to detect whether the input signal from the external environment includes a human voice part S1. In this embodiment, the input signal received by the neural network-like human voice detection module NVD from the external environment only includes the human voice part S1. When the neural network-like human voice detection module NVD detects the human voice part S1 in the input signal, the frequency shifting module FL will use a frequency shifting method to shift the human voice part S1 from high-frequency to low-frequency to generate an enhanced human voice part S1′ and then Output it.

It should be noted that the frequency shifting module FL can use any frequency shifting method (such as a frequency shifting algorithm) to perform frequency shifting processing on the human voice part S1 to lower its high-frequency components to low-frequency components, and the needs of different users (for example, hearing-impaired persons with different degrees of hearing-impairment) can be met by adjusting parameters.

In this way, because the audio signal enhancement system 1 only shifts the human voice part S1 that the hearing-impaired person needs to hear to low-frequency without any environmental noise part being shifted to low-frequency, so it is easier for the hearing-impaired person to hear the human voice part S1 and it helps to improve the semantic understanding of the human voice part S1 for the hearing-impaired person, effectively solving various problems encountered in the prior art.

Please refer to FIG. 2, which is a schematic diagram of an audio signal enhancement system 2 according to a second preferred embodiment of the invention. As shown in FIG. 2, the audio signal enhancement system 2 includes a neural network-like human voice detection module NVD and a frequency shifting module FL. The frequency shifting module FL is coupled to the neural network-like human voice detection module NVD. In this embodiment, the input signal received by the neural network-like human voice detection module NVD from the external environment not only includes the human voice part S1, but also includes an environmental noise part S2.

When the neural network-like human voice detection module NVD receives the input signal from the external environment, since the input signal includes the human voice part S1 and the environmental noise part S2 at the same time, the neural network-like human voice detection module NVD will detect the human voice part S1 in the input signal, and then the frequency shifting module FL will perform frequency shifting processing on the human voice part S1 to shift the human voice part S1 from high-frequency to low-frequency through a frequency shifting algorithm to generate an enhanced human voice part S1′ and then output it.

Thus, although the input signal from the external environment includes the human voice part S1 and the environmental noise part S2 at the same time, the audio signal enhancement system 2 only shifts the human voice part S1 that the hearing-impaired person needs to hear to low-frequency. No environmental noise part S2 will be shifted to low-frequency, so it is easier for the hearing-impaired person to hear the human voice part S1 and it helps to improve the semantic understanding of the human voice part S1 for the hearing-impaired person, effectively solving the problem Various problems encountered in prior art.

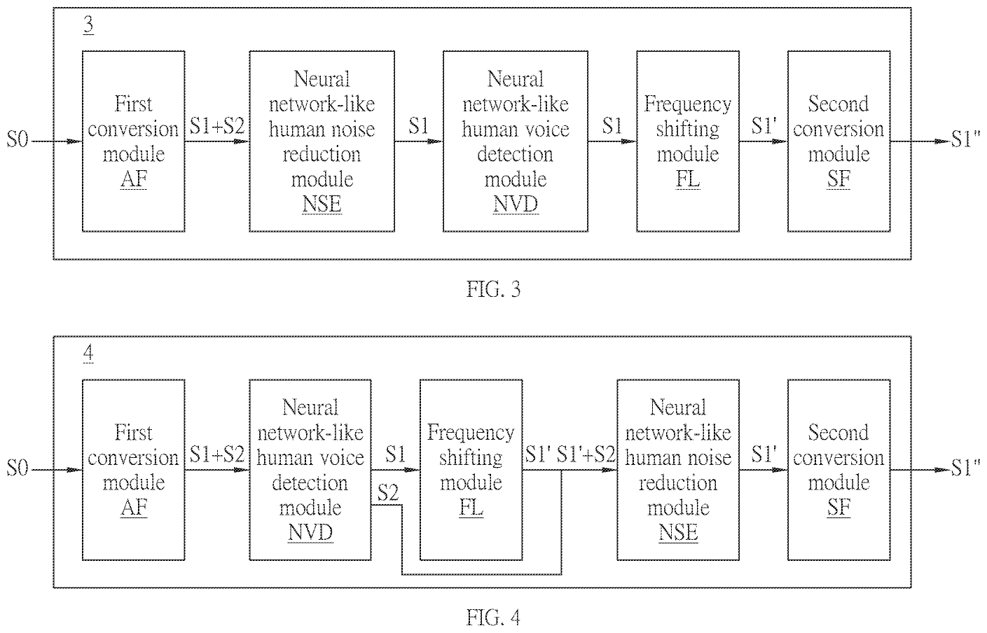

Please refer to FIG. 3, which is a schematic diagram of an audio signal enhancement system 3 according to a third preferred embodiment of the invention. As shown in FIG. 3, the audio signal enhancement system 3 includes a first conversion module AF, a neural network-like human noise reduction module NSE, a neural network-like human voice detection module NVD, a frequency shifting module FL and a second conversion module SF. The neural network-like noise reduction module NSE is coupled to the first conversion module AF. The neural network human voice detection module NVD is coupled to the neural network human noise reduction module NSE. The frequency shifting module FL is coupled to the neural network-like human voice detection module NVD. The second converting module SF is coupled to the frequency shifting module FL.

In this embodiment, when the first conversion module AF receives an original signal S0 from the external environment (for example, obtained through a microphone), the first conversion module AF can perform Fourier transformation (Short-time Fourier Transform (STFT) for example) on the original signal S0, so the original signal S0 will be converted into an input signal including a human voice part S1 and an environmental noise part S2 at the same time, and then output the input signal to the neural network-like human voice noise reduction module NSE. In addition, the first conversion module AF may also include a filter bank or an analysis filter, but not limited to this.

When the neural network-like human voice noise reduction module NSE receives the input signal including the human voice part S1 and the environmental noise part S2, the neural network-like human voice noise reduction module NSE will eliminate the environmental noise part S2 and retain the human voice part S1, and then output the human voice part S1 to the neural network-like human voice detection module NVD.

When the neural network-like human voice detection module NVD receives and detects the human voice part S1, the neural network-like human voice detection module NVD will output the human voice part S1 to the frequency shifting module FL, and then the frequency shifting module FL will perform the frequency shifting processing on the human voice part S1 to shift the human voice part S1 from high-frequency to low-frequency through a frequency shifting algorithm to generate an enhanced human voice part S1′, and the enhanced human voice part S1′ is then outputted to the second conversion module SF. The second conversion module SF will perform an inverse Fourier transform on the enhanced human voice part S1′ to generate an enhanced output signal S1″, and then outputs the enhanced output signal S1″ to the outside through, for example, a speaker.

In this way, although the original signal S0 received through the microphone includes the human voice part S1 and the environmental noise part S2 at the same time, the audio signal enhancement system 3 uses the neural network-like human voice noise reduction module NSE to eliminate the environmental noise part S2, and only the human voice part S1 that the hearing-impaired person needs to hear is shifted to the low-frequency without any environmental noise part S2 being moved to the low-frequency, so that the hearing-impaired person can hear the human voice more easily S1 is also helpful to improve the semantic understanding of the human voice part S1 for the hearing-impaired person, and various problems encountered in the prior art can be effectively solved.

Please refer to FIG. 4, which is a schematic diagram of an audio signal enhancement system according to a fourth preferred embodiment of the invention. As shown in FIG. 4, the audio signal enhancement system 4 includes a first conversion module AF, a neural network-like human voice detection module NVD, a frequency shifting module FL, a neural network-like human noise reduction module NSE and a second conversion module SF. The neural network-like human voice detection module NVD is coupled to the first conversion module AF. The frequency shifting module FL is coupled to the neural network-like human voice detection module NVD. The neural network-like human noise reduction module NSE is coupled to the frequency shifting module FL and the neural network-like human voice detection module NVD respectively. The second conversion module SF is coupled to the neural network-like noise reduction module NSE.

In this embodiment, when the first conversion module AF receives the original signal S0 from the external environment (for example, obtained through a microphone), the first conversion module AF will perform Fourier transformation on the original signal S0 to convert the original signal S0 into an input signal including both the human voice part S1 and the environmental noise part S2, and then output to the neural network-like human voice detection module NVD.

When the neural network-like human voice detection module NVD receives the input signal including the human voice part S1 and the environmental noise part S2, the neural network-like human voice detection module NVD can detect the human voice part S1 and output the human voice part S1 to the frequency shifting module FL.

At the same time, the neural network-like human voice detection module NVD will also output the environmental noise part S2 to the neural network-like human noise reduction module NSE.

When the frequency shifting module FL receives the human voice part S1, the frequency shifting module FL will perform frequency shifting processing on the human voice part S1 from high-frequency to low-frequency through a frequency shifting algorithm to generate an enhanced human voice part S1′ and the enhanced human voice part S1′ is then output to the neural network-like human noise reduction module NSE. When the neural network human noise reduction module NSE receives the enhanced human voice part S1′ and the environmental noise part S2 respectively, the neural network human voice noise reduction module NSE will eliminate the environmental noise part S2 and retain the enhanced human voice part After S1′, the enhanced human voice part S1′ is output to the second conversion module SF. The second conversion module SF performs an inverse Fourier transform on the enhanced human voice part S1′ to generate an enhanced output signal S1″, and then outputs the enhanced output signal S1″ to the outside through, for example, a speaker.

In this way, although the original signal S0 received through the microphone includes the human voice part S1 and the environmental noise part S2 at the same time, because the audio signal enhancement system 4 uses the neural network-like human voice noise reduction module NSE to eliminate the environmental noise part S2 is d, and the hearing-impaired person will only hear the human voice part S1 that has been shifted to low-frequency without hearing any environmental noise part S2, so that the hearing-impaired person can hear the human voice part S1 more easily and it helps to improve the semantic understanding of the human voice part S1 for the hearing-impaired person, and various problems encountered in the prior art can be effectively solved.

For example, when the audio signal enhancement system of the invention is applied to a hearing aid, the audio signal enhancement system uses the neural network-like human voice noise reduction method used by the neural network-like human voice noise reduction module with the frequency shifting module. The frequency shifting algorithm used to provide new functions of hearing aids for the hearing-impaired person. Since the frequency shifting algorithm used by the frequency shifting module can meet the needs of different users through parameter adjustment, it is suitable for mild to severe hearing loss. If the hearing aid does not use the audio signal enhancement system of the invention, the output signal may not be able to perform frequency shifting processing for the human voice or the signal-to-noise ratio may not be improved, resulting in poor hearing aid effect provided by the hearing aid.

Compared to the prior art, the audio signal enhancement system of the invention is a frequency shifting system combined with a neural network-like noise reduction system and the powerful modeling ability of a neural network is used to determine whether the environment contains a human voice part and an arbitrary frequency shifting method is used to shift only the human voice part to avoid that noise is also frequency-shifted to ensure the maintenance of semantic understanding. At the same time, it is equipped with a neural network-like noise reduction module to preserve the human voice part and eliminate environmental noise part to avoid confusion for the hearing-impaired person and improve their semantic understanding.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An audio signal enhancement system, comprising:
a neural network-like human voice detection module, configured to receive an input signal and detect a human voice part of the input signal; and
a frequency shifting module, coupled to the neural network-like human voice detection module and configured to perform a frequency shifting process on the human voice part to generate an enhanced human voice part.

2. The audio signal enhancement system of claim 1, wherein the audio signal enhancement system further comprises:
a neural network-like human voice noise reduction module, coupled to the neural network-like human voice detection module and configured to eliminate an environmental noise part in the input signal and then output it to the neural network-like human voice detection module.

3. The audio signal enhancement system of claim 2, wherein the audio signal enhancement system further comprises:
a first conversion module, coupled to the neural network-like human voice noise reduction module and configured to convert an original signal into the input signal and then output it to the neural network-like human voice noise reduction module.

4. The audio signal enhancement system of claim 2, wherein the audio signal enhancement system further comprises:
a second conversion module, coupled to the frequency shifting module and configured to convert the enhanced human voice into an enhanced output signal and then output the enhanced output signal.

5. The audio signal enhancement system of claim 1, wherein the input signal further comprises an environmental noise part; the audio signal enhancement system further comprises:
a neural network-like human voice noise reduction module, coupled to the frequency shifting module and the neural network-like human voice detection module and configured to receive the enhanced human voice part and the environmental noise part and eliminate the environmental noise part and then output the enhanced human voice part.

6. The audio signal enhancement system of claim 5, further comprises:
a first conversion module, coupled to the neural network-like human voice detection module and configured to convert the original signal into the input signal and output the input signal to the neural network-like human voice detection module.

7. The audio signal enhancement system of claim 5, further comprises:
a second conversion module, coupled to the neural network-like human voice noise reduction module and configured to convert the enhanced human voice part into an enhanced output signal for output.

8. The audio signal enhancement system of claim 1, wherein the frequency shifting module uses any frequency shifting method to perform frequency shifting processing on the human voice part to shift its high-frequency components to low-frequency components, and the needs of different users are met through parameter adjustment.
